(19) United States
(12) Patent Application Publication
(10) Pub. No.: US 2013/0132981 A1
(43) Pub. Date: May 23, 2013

(54) Interactive Webisodic or Episodic Product Presentation and Sales System

(71) Applicant: Lauralee Bell Martin, Los Angeles, CA (US)

(72) Inventor: Lauralee Bell Martin, Los Angeles, CA (US)

(21) Appl. No.: 13/475,875

(22) Filed: May 18, 2012

Related U.S. Application Data
(60) Provisional application No. 61/487,657, filed on May 18, 2011.

(51) Int. Cl. H04N 21/2543

(52) U.S. Cl. CPC H04N 21/2543
USPC 725/5

(57) ABSTRACT

An interactive webisodic or episodic product presentation and sales system has a processor and tangible, non-transitory media that stores a program that when executed by the processor is configured to perform operations. The operations include receiving a request from a requesting user to play one of a webisodic or episodic presentation on a display. A webisodic or episodic presentation is then presented on a display, during which at least one of a product or service is highlighted. On the same screen as the presentation, the system displays a purchasing option to the user to purchase the highlighted product or service. When a purchase order is received from the user; the system fulfills the purchase order. The highlighted product or service may be available exclusively in conjunction with the display of the webisodic or episodic presentation.

### RELATED APPLICATIONS

This application claims priority from U.S. Provisional Patent Application No. 61/487,657 on “Interactive Webisodic or Episodic Product Presentation and Sales System,” which was filed May 18, 2011 and which is incorporated in its entirety herein.

### BACKGROUND OF THE INVENTION

Episodic entertainment is available in a variety of mediums, such as television, radio, and the Internet. A popular form of episodic entertainment on the Internet is the “webisode,” which is part of a web series. A “webisode” characteristically features a dramatic or comedic, serial storyline, where the primary method of viewership is streaming online over the Internet. While there is no set standard for length, most webisodes are relatively short, often ranging from 4-15 minutes in length, although the present invention may be extended to episodes of longer duration.

Separate and apart from webisodes, there are several common approaches to selling fashion retail on the Internet. Traditional web-based retailers such as department store sites, Amazon.com and EBay offer shoppers a multitude of products for purchase. However, on these traditional websites, products are presented in a static fashion, most often with a photo of the product and a product description. The product is not presented in a broader context in which a shopper experiences a fuller vision of the product and how it might be used by the shopper.

There is a need in the art for a system and method for fusing fashion retail and episodic entertainment.

### SUMMARY OF THE INVENTION

In one embodiment, the present invention relates to an interactive webisodic or episodic product presentation and sales system, which has a processor and tangible, non-transitory media that stores a program that when executed by the processor is configured to perform operations. The operations include receiving a request from a requesting user to play one of a webisodic or episodic presentation on a display. A webisodic or episodic presentation is then presented on a display, during which at least one of a product or service is highlighted. On the same screen as the presentation, the system displays a purchasing option to the user to purchase the at least one highlighted product or service. When a purchase order is received from the user; the system fulfills the purchase order.

The system may include other specific features. The system may, for example, display further pages of information to the user upon demand. These further pages of information may include at least one of a selection of episodes, information about the cast and/or the show, and frequently asked questions.

The system may present the user with the opportunity to be redirected to one or more external websites. The external website may be, for example, a product or service website. Alternatively, the system may keep the user on the initial website and conduct ordering and/or payment operations within the initial website. As a further alternative, primary purchasing functions may be carried out on a first website, with the user redirected to a second website primarily to handle payment functions.

In one embodiment, the product is at least one fashion item, and the presentation includes a dramatic production in which the fashion item appears. In another embodiment, the system further displays a tag on the screen and, upon the user clicking on the tag, receiving a request to initiate a purchase process.

In an alternative embodiment, the system further includes receiving a request from the user to freeze the displayed frame and freezing the frame. The system may further include receiving instructions from the user to alter an aspect of a product displayed on the screen. The screen may be any of a variety of suitable screens, such as a television, a computer monitor, a smartphone, and a tablet.

The system may also include displaying a selection of episodes, receiving instructions from the user to play a particular episode, and receiving an order to purchase one of a product or service featured in the particular episode.

The aforementioned features may be combined in a variety of different ways to form different embodiments. It should also be understood that the foregoing Summary is not a complete description of the inventive features and aspects of the invention. Other features and advantages of the present invention will become more apparent from the following Detailed Description, taken in conjunction with the drawings, and from the claims.

### BRIEF DESCRIPTION OF THE DRAWINGS

FIG. 1 illustrates a web screen design having a viewing window for user viewing of a webisode, and a product purchase are beneath the viewing window for purchasing one or more products featured in webisode;

FIG. 2 is a detail view of the screen of FIG. 1, illustrating in particular the product purchase area of the webscreen;

FIG. 3 illustrates a non-limiting example of a third-party payment system through which the viewer may purchase and pay for an item featured in a particular webisode.

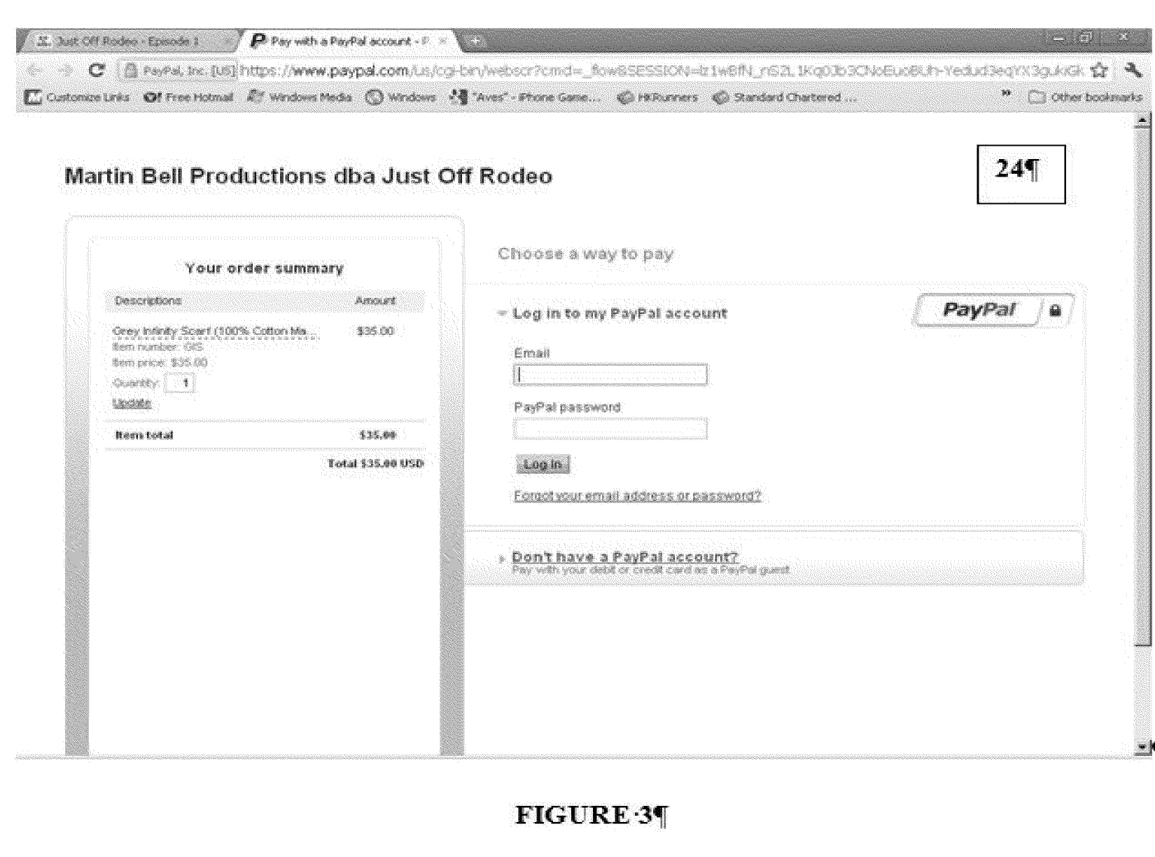

FIG. 4 illustrates a webpage from which the user may access additional webpages for further information and the like.

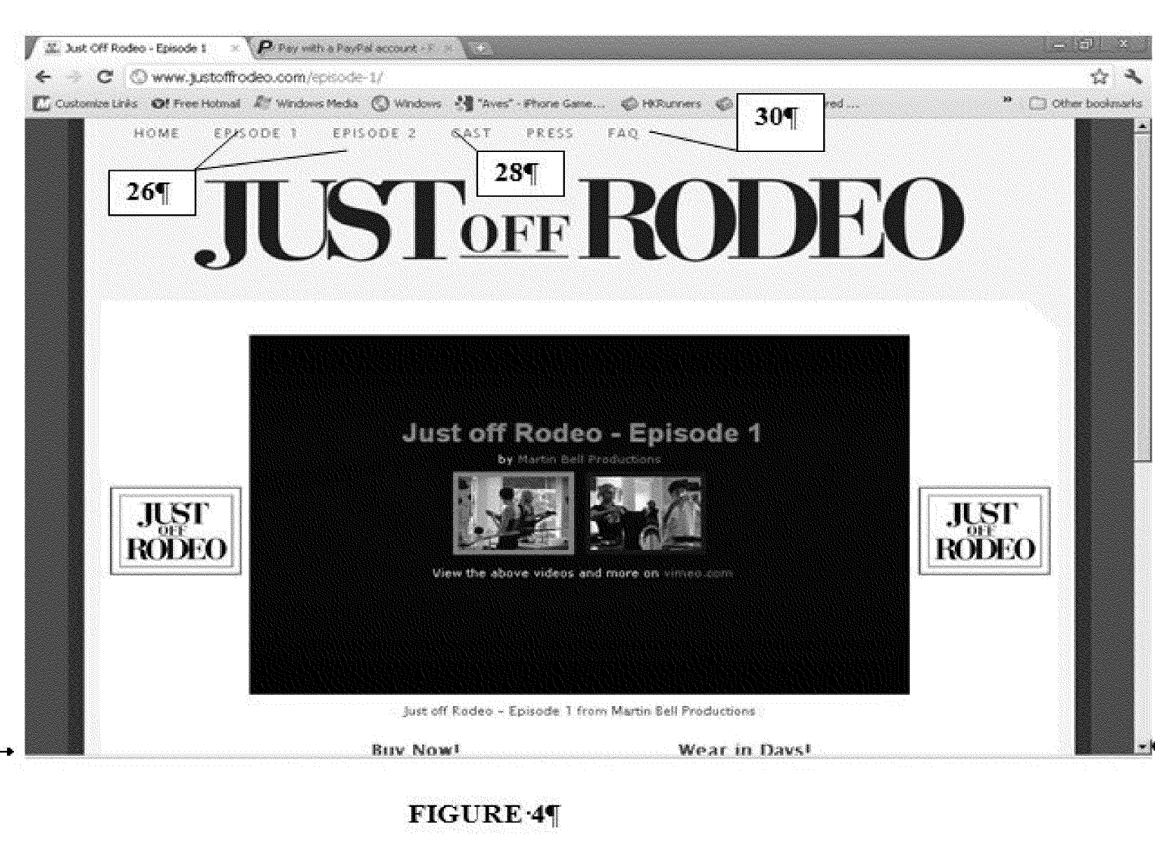

### DETAILED DESCRIPTION OF THE PREFERRED EMBODIMENTS

The present invention relates to fusing episodic entertainment with fashion retail sales. The present invention includes a system and method in which merchandise that users may purchase are featured in the creative content of a webisode available for viewing on the Internet. If, for example, an actress is wearing an attractive blouse, a viewer can click to buy the exact type of item that the actress is wearing and have it delivered via UPS or mail, for example. The webisode features creative content, with fashion built into the story and appearing on the screen. In one embodiment, a series surrounds the daily activities happening in a clothing boutique, and provisions are made such that viewers can purchase the clothes seen on the characters or otherwise featured on the show.

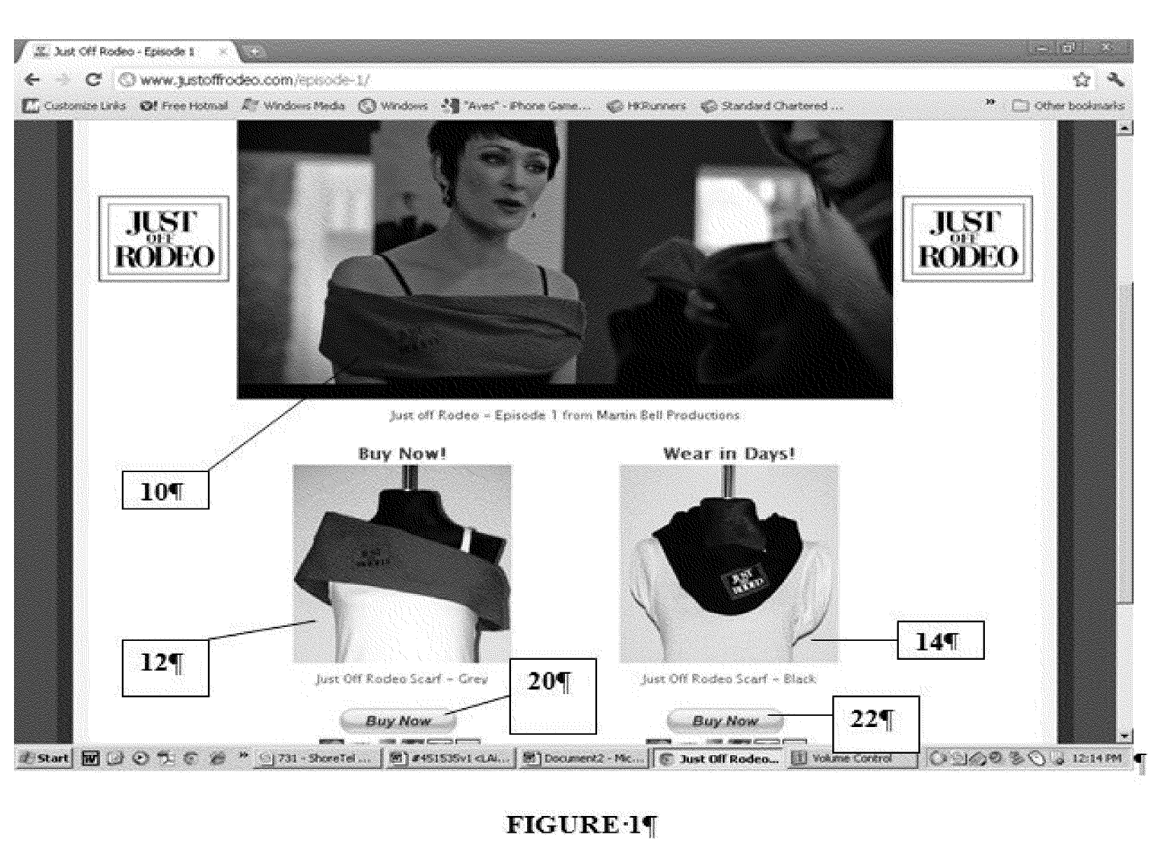

In one embodiment, a designer makes a line of clothing for a limited number of episodes. In another embodiment, a celebrity can make a guest appearance with the item. A figure showing a webisodic episode featuring a product appears in FIG. 1. In the screen of FIG. 1, an episode viewing area 10 features the webisodic presentation. Beneath the viewing frame, products 12, 14 are offered for sale. The user can purchase the items via a simple click-through arrangement, or any other manner of purchasing items on the Internet known in the art.

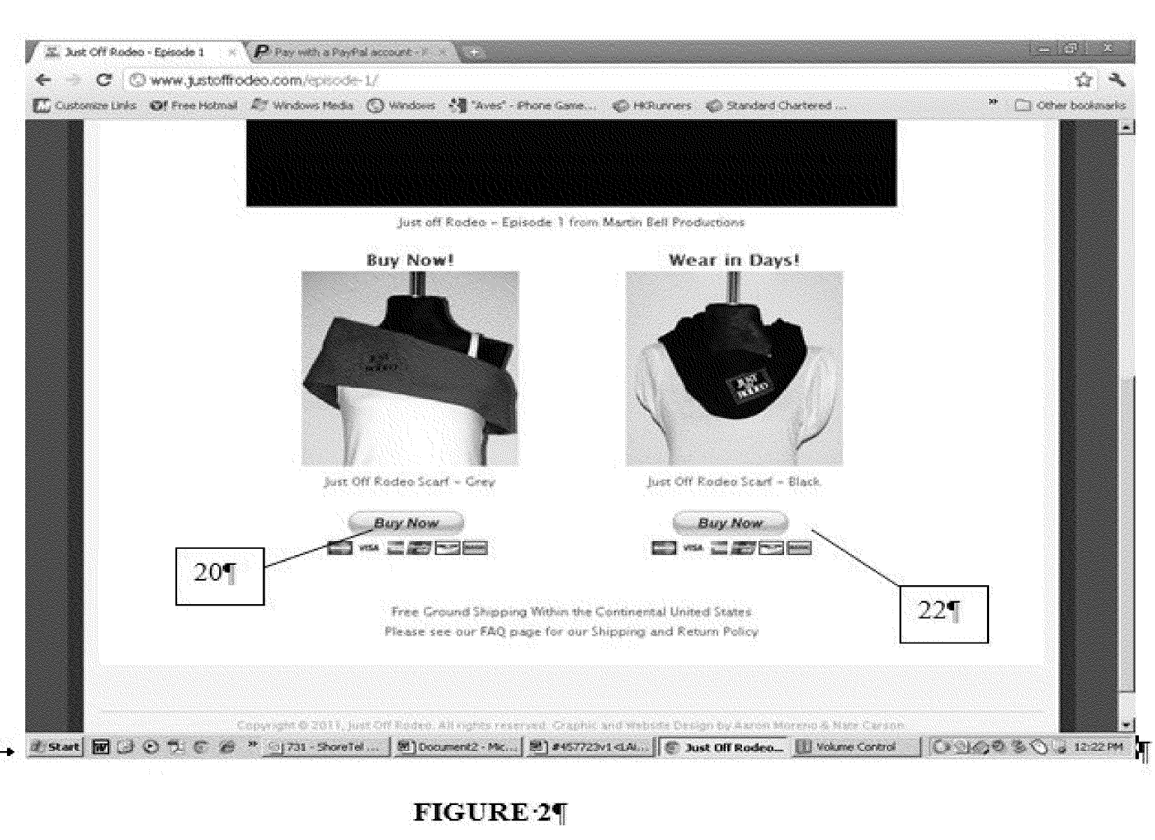

In one embodiment, illustrated in FIG. 2, a simple button 20 and/or 22 is presented to the user. The user clicks on the button to initiate the purchase process. The website may then direct the user to a payment website, such as PAYPAL or another commercial payment website 24.

As one example, the webisode briefly illustrated in FIG. 1 may feature characters such as shopgirls and a male hairdresser inside a trendy boutique. The “for-sale” merchandise, in one example a shawl and a T-shirt that are both imprinted with a logo, are presented as part of the storyline.

The website may feature further pages of information. For example, the user may be presented with a selection of episodes 26, information about the cast and/or the show 28, frequently asked questions 30, or a variety of other information. The user may also be presented with the opportunity to be redirected to one or more external websites, such as product websites and the like.

In one embodiment of the invention, one or more characters in the series would look different in some respect in every episode. Characters may, from time-to-time, reinvent themselves. The audience becomes excited to watch each new episode, as it is unknown what the new look will be and what new items will be for sale. A designer could, for example, design just one item specifically for the show, make a cameo appearance in the series, or otherwise make a particular episode special.

In one episode, as illustrated in FIG. 1 above, two scarves are available for purchase. In another episode, different color stylish t-shirts are featured. In the embodiment of FIG. 1, as previously discussed, beneath the episode player are two choices for buying the items. The viewer can click on the item and purchase it, with the purchased item arriving via mail or other shipping method. Although clothing is featured in the webisodes, it is the intention that the clothing does not take away from the story.

Proceeds from the sales of the items may be used in a variety of ways, including a “for profit” retail operation, a charitable operation, and any of a number of commercial variations.

Although one embodiment is a webisode available for viewing on an Internet website, other variations are possible. Rather than a webisode, the show may be a television show, a video game, or may be presented in another format.

More generally, the present concept may be implemented in a variety of different forms. For example, a system may be provided enabling the user to freeze the webisode on a particular frame, click on an item of interest, and be provided with onscreen means to purchase the item or to learn more about it. However, the primary embodiment is of a more simple nature, in which an episode features a small number of featured products and the user is provided with a simple means for purchasing one or more of the small number of featured products. In one embodiment, the product or service for sale is available only on the website on which the user is watching the webisode or episode. That is, the product or service is exclusive to the site, and not available for purchase elsewhere.

Other modifications and improvements may be made without departing from the scope of the invention. For example, there are alternative methods by which a user can order products. In one alternative embodiment, the viewer clicks on a tag on the screen to order a product. For instance, the system may be configured to permit the user to freeze the frame and click on the desired product within the frame to begin the purchasing process. As another option, the system may be configured to permit the viewer to alter aspects of what is displayed, such as by clicking on a product shown on the screen in order to change its color or the like.

Other variations are possible. The present invention is not limited to personal computer screens. The concept encompasses other types of displays, such as web-enabled television. In one such approach, products may be ordered with the television remote control.

In still another embodiment, featured merchandise may be available exclusively on the website. In some instances, the merchandise is not even featured on an episode, yet is exclusively available for purchase through the website.

Other modifications and improvements may be made without departing from the scope of the invention.

What is claimed is:

1. An interactive webisodic or episodic product presentation and sales system comprising:
a processor;
tangible, non-transitory media that stores a program that when executed by the processor is configured to perform operations, comprising:
receiving a request from a requesting user to play one of a webisodic or episodic presentation on a display;
displaying a webisodic or episodic presentation on a display, during which at least one of a product or service is highlighted;
on the same screen as the presentation, displaying a purchasing option to the user to purchase the at least one highlighted product or service;
receiving a purchase order from the user;
fulfilling the purchase order.

2. A system as described in claim 1, wherein the system displays further pages of information to the user upon demand.

3. A system as described in claim 2, wherein the further pages of information comprise at least one of a selection of episodes, information about the cast and/or the show, frequently asked questions.

4. The system as described in claim 1, wherein the system presents the user with the opportunity to be redirected to one or more external websites.

5. The system as described in claim 4, wherein the external website comprises a product website.

6. The system as described in claim 1, wherein the product is at least one fashion item, and wherein the presentation comprises a dramatic production in which the fashion item appears.

7. The system as described in claim 1, wherein the system further comprises displaying a tag on the screen and, upon the user clicking on the tag, receiving a request to initiate a purchase process.

8. The system as described in claim 7, wherein the system further comprises receiving a request from the user to freeze the displayed frame and freezing the frame.

9. The system as described in claim 1, wherein the system further includes receiving instructions from the user to alter an aspect of a product displayed on the screen.

10. The system as described in claim 1, wherein the presentation is displayed on a television.

11. The system as described in claim 1, wherein the presentation is displayed on one of a smartphone and a tablet.

12. The system as described in claim 1, wherein the system further comprises displaying a selection of episodes, receiving instructions from the user to play a particular episode, and receiving an order to purchase one of a product or service featured in the particular episode.

13. The system as described in claim 1, wherein said product or service is exclusive to a particular site, and unavailable for purchase elsewhere.

14. The system as described in claim 1, wherein the system handles a purchasing process internally.

15. The system as described in claim 1, wherein the system handles a purchasing process internally, and redirects the user to a separate site for handling payment.

16. An interactive webisodic or episodic product presentation and sales system comprising:
a processor;
tangible, non-transitory media that stores a program that when executed by the processor is configured to perform operations, comprising:
receiving a request from a requesting user to play one of a webisodic or episodic presentation on a display;
displaying a webisodic or episodic presentation on a display, during which at least one of a product or service is highlighted;
on the same screen as the presentation, displaying a purchasing option to the user to purchase the at least one highlighted product or service;
receiving a purchase order from the user;
fulfilling the purchase order;
displaying further pages of information to the user upon demand, wherein the further pages of information comprise at least one of a selection of episodes, information about the cast and/or the show, frequently asked questions;
displaying a selection of episodes, receiving instructions from the user to play a particular episode, and receiving an order to purchase one of a product or service featured in the particular episode; and
said product or service being exclusive to a particular site, and unavailable for purchase elsewhere.
